(19) United States
(12) Patent Application Publication
(10) Pub. No.: US 2025/0071805 A1
(43) Pub. Date: Feb. 27, 2025

(54) USER EQUIPMENT PERFORMANCE INDICATION IN RANDOM ACCESS

(71) Applicant: QUALCOMM Incorporated, San Diego, CA (US)

(72) Inventors: Diana MAAMARI, San Diego, CA (US); Ahmed Attia ABOTABL, San Diego, CA (US); Marwen ZORGUI, San Diego, CA (US)

(21) Appl. No.: 18/456,210

(22) Filed: Aug. 25, 2023

(51) Int. Cl. H04W 74/00; H04W 72/543; H04W 74/08

(52) U.S. Cl. CPC H04W 74/004; H04W 72/543; H04W 74/0833

(57) ABSTRACT

Various aspects of the present disclosure generally relate to wireless communication. In some aspects, a user equipment (UE) may transmit a communication of a random access channel (RACH) procedure using a RACH occasion, of a plurality of RACH occasions, or a RACH preamble, of a plurality of RACH preambles, to indicate a value for a performance indicator associated with the UE, or using a physical uplink shared channel (PUSCH) occasion and indicating the value for the performance indicator in the communication. The UE may receive, in response to the communication of the RACH procedure, an additional communication of the RACH procedure. Numerous other aspects are described.

### FIELD OF THE DISCLOSURE

Aspects of the present disclosure generally relate to wireless communication and to techniques and apparatuses for user equipment performance indication in random access.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting a communication of a random access channel (RACH) procedure using a RACH occasion, of a plurality of RACH occasions, or a RACH preamble, of a plurality of RACH preambles, to indicate a value for a performance indicator associated with the UE, or using a physical uplink shared channel (PUSCH) occasion and indicating the value for the performance indicator in the communication. The method may include receiving, in response to the communication of the RACH procedure, an additional communication of the RACH procedure.

Some aspects described herein relate to a method of wireless communication performed by a network node. The method may include receiving a communication of a RACH procedure that uses a RACH occasion, of a plurality of RACH occasions, or a RACH preamble, of a plurality of RACH preambles, to indicate a value for a performance indicator associated with a UE, or that uses a PUSCH occasion and indicates the value for the performance indicator in the communication. The method may include transmitting, in response to the communication of the RACH procedure, an additional communication of the RACH procedure.

Some aspects described herein relate to an apparatus for wireless communication at a UE. The apparatus may include one or more memories and one or more processors coupled to the one or more memories. The one or more processors may be configured to cause the UE to transmit a communication of a RACH procedure using a RACH occasion, of a plurality of RACH occasions, or a RACH preamble, of a plurality of RACH preambles, to indicate a value for a performance indicator associated with the UE, or using a PUSCH occasion and indicating the value for the performance indicator in the communication. The one or more processors may be configured to cause the UE to receive, in response to the communication of the RACH procedure, an additional communication of the RACH procedure.

Some aspects described herein relate to an apparatus for wireless communication at a network node. The apparatus may include one or more memories and one or more processors coupled to the one or more memories. The one or more processors may be configured to cause the network node to receive a communication of a RACH procedure that uses a RACH occasion, of a plurality of RACH occasions, or a RACH preamble, of a plurality of RACH preambles, to indicate a value for a performance indicator associated with a UE, or that uses a PUSCH occasion and indicates the value for the performance indicator in the communication. The one or more processors may be configured to cause the network node to transmit, in response to the communication of the RACH procedure, an additional communication of the RACH procedure.

Some aspects described herein relate to a non-transitory computer-readable medium that stores a set of instructions for wireless communication by a UE. The set of instructions, when executed by one or more processors of the UE, may cause the UE to transmit a communication of a RACH procedure using a RACH occasion, of a plurality of RACH occasions, or a RACH preamble, of a plurality of RACH preambles, to indicate a value for a performance indicator associated with the UE, or using a PUSCH occasion and indicating the value for the performance indicator in the communication. The set of instructions, when executed by one or more processors of the UE, may cause the UE to receive, in response to the communication of the RACH procedure, an additional communication of the RACH procedure.

Some aspects described herein relate to a non-transitory computer-readable medium that stores a set of instructions for wireless communication by a network node. The set of instructions, when executed by one or more processors of the network node, may cause the network node to receive a communication of a RACH procedure that uses a RACH occasion, of a plurality of RACH occasions, or a RACH preamble, of a plurality of RACH preambles, to indicate a value for a performance indicator associated with a UE, or that uses a PUSCH occasion and indicates the value for the performance indicator in the communication. The set of instructions, when executed by one or more processors of the network node, may cause the network node to transmit, in response to the communication of the RACH procedure, an additional communication of the RACH procedure.

Some aspects described herein relate to an apparatus for wireless communication. The apparatus may include means for transmitting a communication of a RACH procedure using a RACH occasion, of a plurality of RACH occasions, or a RACH preamble, of a plurality of RACH preambles, to indicate a value for a performance indicator associated with the apparatus, or using a PUSCH occasion and indicating the value for the performance indicator in the communication. The apparatus may include means for receiving, in response to the communication of the RACH procedure, an additional communication of the RACH procedure.

Some aspects described herein relate to an apparatus for wireless communication. The apparatus may include means for receiving a communication of a RACH procedure that uses a RACH occasion, of a plurality of RACH occasions, or a RACH preamble, of a plurality of RACH preambles, to indicate a value for a performance indicator associated with a UE, or that uses a PUSCH occasion and indicates the value for the performance indicator in the communication. The apparatus may include means for transmitting, in response to the communication of the RACH procedure, an additional communication of the RACH procedure.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers. modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a four-step random access procedure, in accordance with the present disclosure.

FIG. 5 is a diagram illustrating an example of a two-step random access procedure, in accordance with the present disclosure.

FIG. 6 is a diagram illustrating examples of delay status reporting and delay statistics reporting, in accordance with the present disclosure.

FIG. 7 is a diagram of an example associated with UE performance indication in random access, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

There are existing and ongoing efforts to configure cellular networks to support extended reality (XR) traffic, which is an umbrella term that covers immersive technologies such as virtual reality (VR), augmented reality (AR), mixed reality (MR), and levels of virtuality interpolated among VR, AR, and MR. XR is expected to improve productivity and convenience for consumers, enterprises, and public institutions in various application areas such as entertainment, training, education, remote support, remote control, communications, and/or virtual meetings, among other examples.

Configuring a wireless network to support the latency requirements, quality of experience (QoE) requirements, high data rates, and/or other characteristics associated with XR traffic presents various challenges. In some examples, delay status reporting and/or delay statistics reporting may be useful to schedule delay-sensitive traffic, such as XR traffic, efficiently. For example, a user equipment (UE) may report a remaining delay budget (RDB) for buffered uplink data, which indicates how soon a network node needs to provide uplink grants. Specifically, the RDB may be defined as a difference between a packet delay budget (PDB) or a protocol data unit (PDU) set delay budget (PSDB) of a quality of service (QoS) flow associated with a PDU and the time that has elapsed since the PDU was received at a service data adaptation protocol (SDAP) layer. In this way, the network node may know the RDB for buffered uplink data and issue uplink grants before the deadline associated with the buffered uplink data.

However, in some cases, such as during handover of a UE, initial access, or random access for beam failure recovery, among other examples, a network node does not have access to information that indicates the delay status or delay statistics that a UE is experiencing. Consequently, uplink scheduling needs to be deferred until after the UE has established a connection, which increases the delay associated with uplink traffic, which is particularly troublesome for XR services or other traffic associated with delay-sensitive applications and/or a tight delay budget. Relatedly, a network node may lack information that indicates an energy status, a battery status, and/or a power consumption of a UE prior to the UE establishing a connection with the network node. For an ambient Internet-of-Things (IoT) UE, an energy harvesting UE, or the like, this information may enable the network node to provide uplink scheduling for the UE in a manner that conserves energy, extends battery life, or the like.

Various aspects relate generally to wireless communication and more particularly to UE performance indication in random access. Some aspects more specifically relate to techniques to inform a network node, during a random access procedure (e.g., a random access channel (RACH) procedure), of information relating to a performance indicator (e.g., a delay status, an energy status, a battery status, and/or a power consumption, among other examples) associated with a UE. By informing the network node of the information during the random access procedure, aspects of the present disclosure allow the network node to start to determine uplink scheduling parameters (e.g., an uplink scheduling priority and/or an uplink grant size) for the UE based on the reported information, thereby facilitating efficient scheduling at the network node. In some aspects, the UE may provide an indication of a value of a performance indicator associated with the UE by transmitting a communication of a RACH procedure using a particular RACH occasion and/or using a particular RACH preamble, where the particular RACH occasion and/or the particular RACH preamble used implicitly indicates the value. By using a particular RACH occasion and/or RACH preamble to indicate the value, aspects of the present disclosure allow the UE to provide a report without the use of additional signaling between the UE and the network node, thereby conserving computing resources of the UE and the network node, and conserving network resources.

In some aspects, the performance indicator may relate to a delay status experienced by the UE. Informing the network node of the delay status associated with the UE allows the network node to schedule the UE as soon as possible, thereby reducing latency (e.g., to satisfy delay requirements for XR or other delay-sensitive traffic). In some aspects, the performance indicator may relate to an energy status, a battery status, and/or a power consumption experienced by the UE. Informing the network node of the energy status, the battery status, and/or the power consumption associated with the UE allows the network node to schedule the UE in a manner that conserves energy, extends battery life, or the like. In some aspects, the network node may provide information to the UE indicating probabilities (e.g., according to a delay status experienced by the UE) of accessing a plurality of RACH occasions. The information may allow the UE to use a RACH occasion associated with a higher probability of the UE accessing the RACH occasion, thereby reducing latency associated with the UE establishing a connection with the network node.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

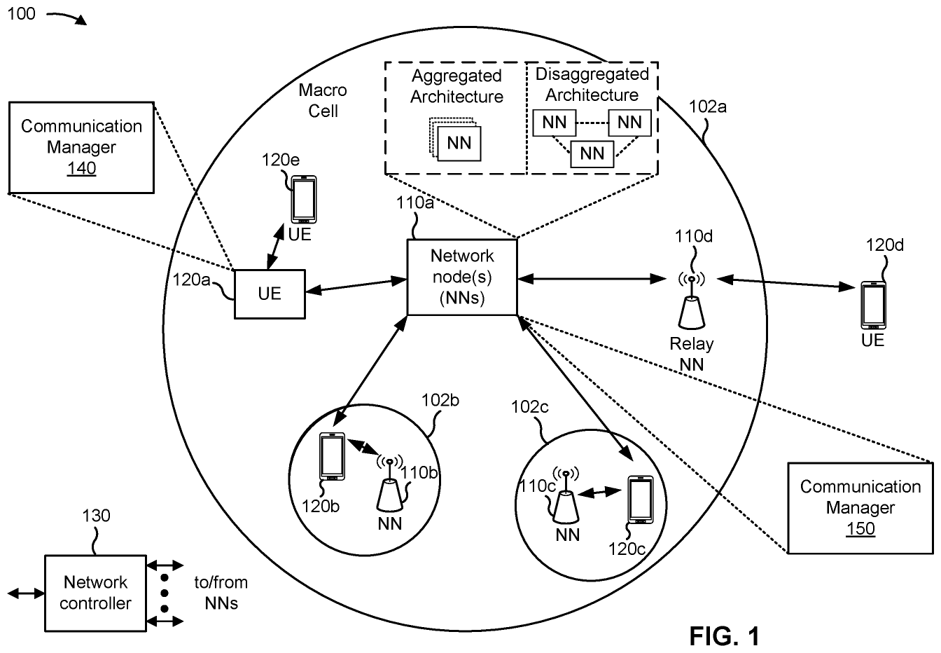

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network clement, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC. or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered IoT devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit a communication of a RACH procedure using a RACH occasion, of a plurality of RACH occasions, or a RACH preamble, of a plurality of RACH preambles, to indicate a value for a performance indicator associated with the UE, or using a physical uplink shared channel (PUSCH) occasion and indicating the value for the performance indicator in the communication; and receive, in response to the communication of the RACH procedure, an additional communication of the RACH procedure. Additionally, or alternatively, the communication manager 140 may perform one or more other operations described herein.

In some aspects, the network node 110 may include a communication manager 150. As described in more detail elsewhere herein, the communication manager 150 may receive a communication of a RACH procedure that uses a RACH occasion, of a plurality of RACH occasions, or a RACH preamble, of a plurality of RACH preambles, to indicate a value for a performance indicator associated with a UE, or that uses a PUSCH occasion and indicates the value for the performance indicator in the communication; and transmit, in response to the communication of the RACH procedure, an additional communication of the RACH procedure. Additionally, or alternatively, the communication manager 150 may perform one or more other operations described herein.

As indicated above, FIG. 1 is provided as an example. Other examples may differ from what is described with regard to FIG. 1.

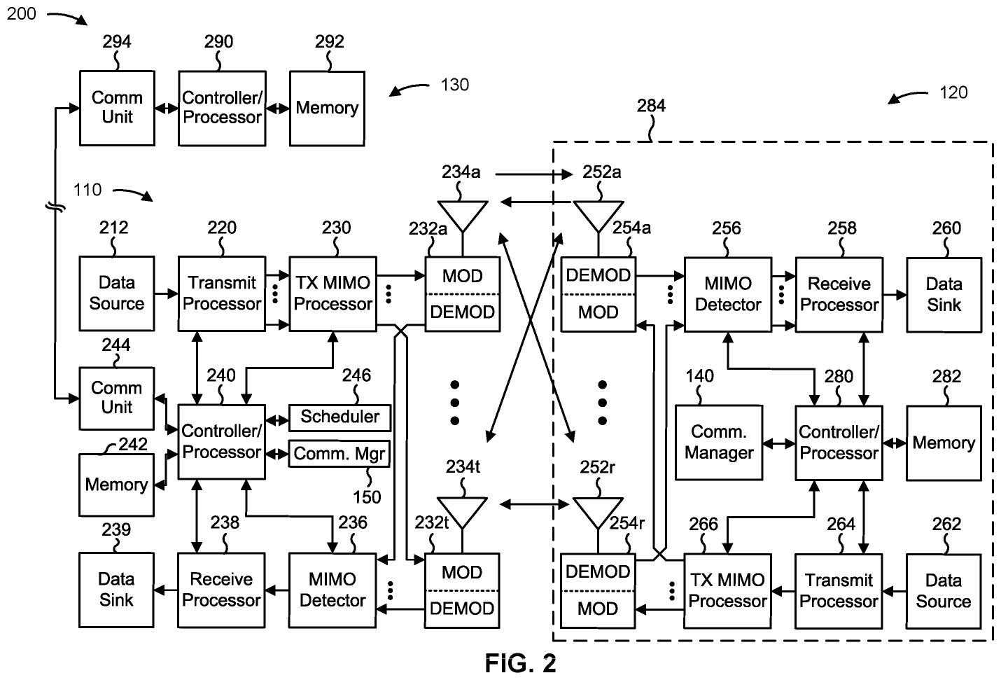

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

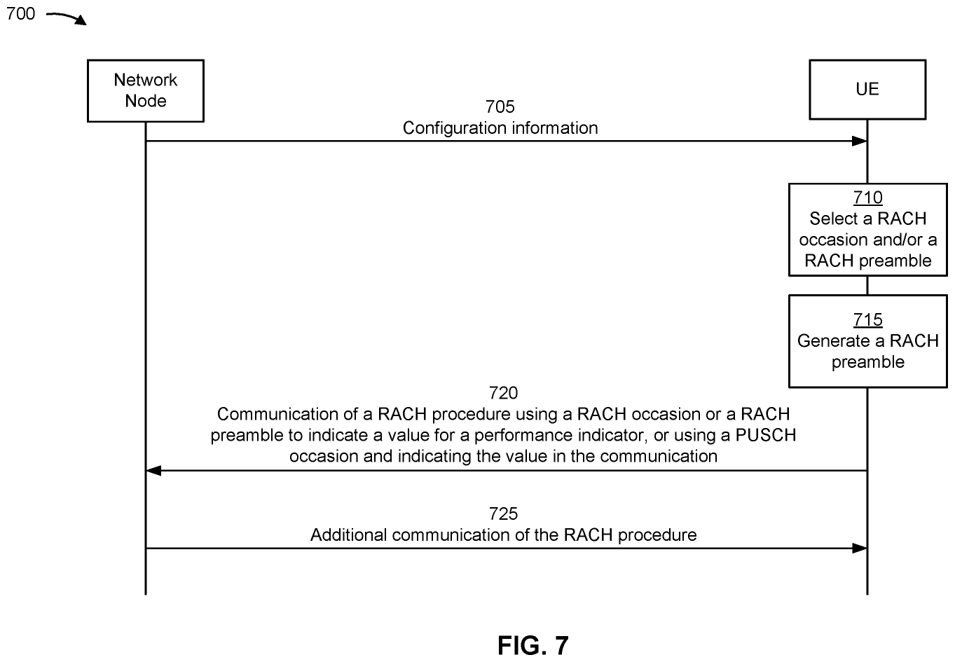

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-11).

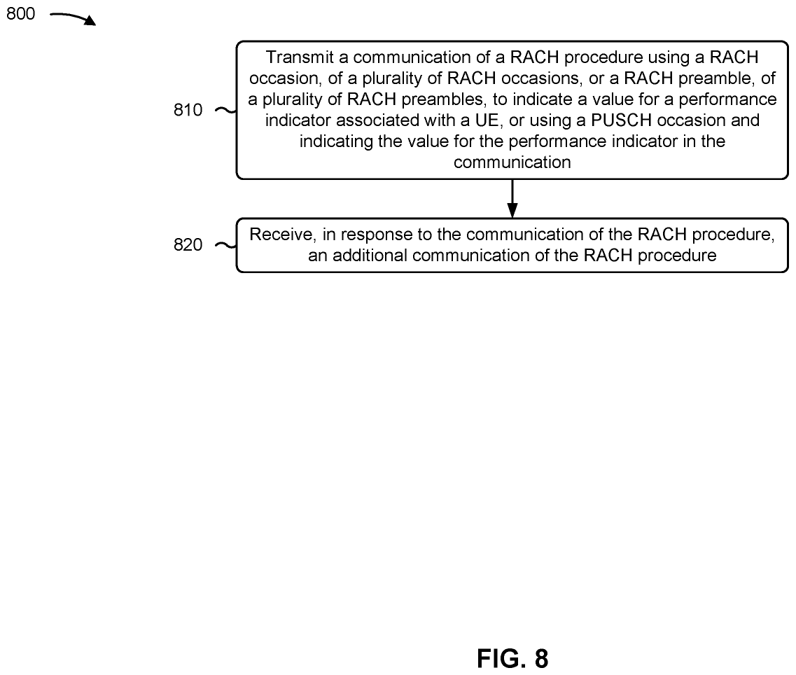

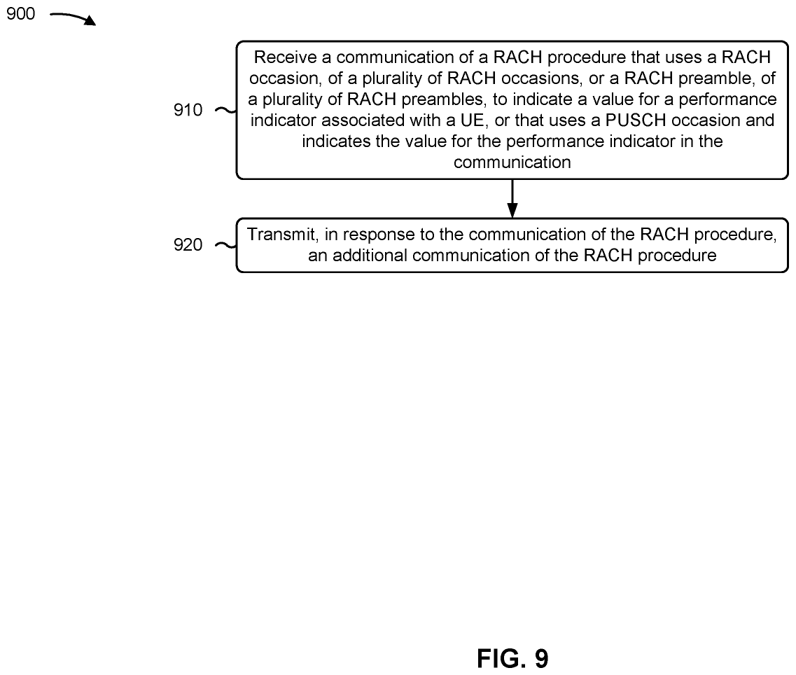

The controller/processor 240 of the network node 110, the controller/processor 280 of the UE 120, and/or any other component(s) of FIG. 2 may perform one or more techniques associated with UE performance indication in random access, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for transmitting a communication of a RACH procedure using a RACH occasion, of a plurality of RACH occasions, or a RACH preamble, of a plurality of RACH preambles, to indicate a value for a performance indicator associated with the UE, or using a PUSCH occasion and indicating the value for the performance indicator in the communication; and/or means for receiving, in response to the communication of the RACH procedure, an additional communication of the RACH procedure. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for receiving a communication of a RACH procedure that uses a RACH occasion, of a plurality of RACH occasions, or a RACH preamble, of a plurality of RACH preambles, to indicate a value for a performance indicator associated with a UE, or that uses a PUSCH occasion and indicates the value for the performance indicator in the communication; and/or means for transmitting, in response to the communication of the RACH procedure, an additional communication of the RACH procedure. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

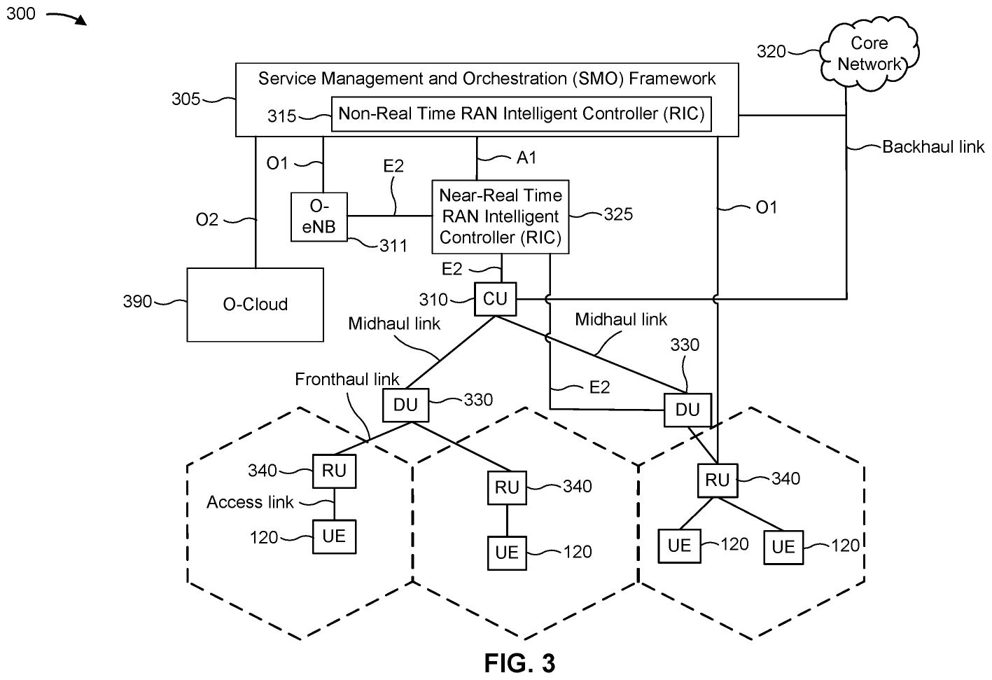

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or SDAP functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-CNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

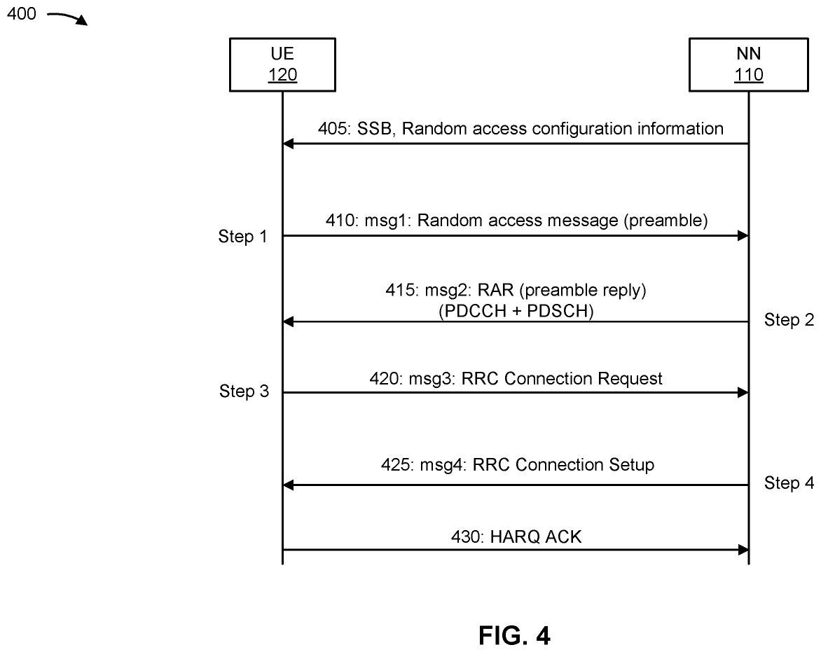

FIG. 4 is a diagram illustrating an example of a four-step random access procedure (e.g., a RACH procedure), in accordance with the present disclosure. As shown in FIG. 4, a network node 110 and a UE 120 may communicate with one another to perform the four-step random access procedure.

As shown by reference number 405, the network node 110 may transmit, and the UE 120 may receive, one or more synchronization signal blocks (SSBs) and random access configuration information. In some examples, the random access configuration information may be transmitted in and/or indicated by system information (e.g., in one or more system information blocks (SIBs)) and/or an SSB, such as for contention-based random access. Additionally, or alternatively, the random access configuration information may be transmitted in a radio resource control (RRC) message and/or a physical downlink control channel (PDCCH) order message that triggers a RACH procedure, such as for contention-free random access (CFRA). The random access configuration information may include one or more parameters to be used in the random access procedure, such as one or more parameters for transmitting a RAM and/or one or more parameters for receiving a random access response (RAR).

As shown by reference number 410, the UE 120 may transmit a random access message (RAM), which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier. In some aspects, the UE may transmit the RAM in a particular RACH occasion and/or using a particular RACH preamble to indicate information relating to a performance indicator associated with the UE, as described herein. A RACH occasion may refer to time and frequency resources that can be used to transmit a communication of a RACH procedure.

As shown by reference number 415, the network node 110 may transmit a RAR as a reply to the preamble. The message that includes the RAR may be referred to as message 2, msg2, MSG2, or a second message in a four-step random access procedure. In some examples, the RAR may indicate the detected random access preamble identifier (e.g., received from the UE 120 in msg1). Additionally, or alternatively, the RAR may indicate a resource allocation to be used by the UE 120 to transmit a third message of a four-step random access procedure.

In some examples, as part of the second step of the four-step random access procedure, the network node 110 may transmit a PDCCH communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 420, the UE 120 may transmit an RRC connection request message. The RRC connection request message may be referred to as message 3, msg3, MSG3, or a third message of a four-step random access procedure. In some examples, the RRC connection request may include a UE identifier, uplink control information (UCI), and/or a PUSCH communication (e.g., an RRC connection request).

As shown by reference number 425, the network node 110 may transmit an RRC connection setup message. The RRC connection setup message may be referred to as message 4, msg4, MSG4, or a fourth message of a four-step random access procedure. In some examples, the RRC connection setup message may include the detected UE identifier, a timing advance value, and/or contention resolution information. As shown by reference number 430, if the UE 120 successfully receives the RRC connection setup message, the UE 120 may transmit a hybrid automatic repeat request (HARQ) acknowledgment (ACK).

As indicated above, FIG. 4 is provided as an example. Other examples may differ from what is described with regard to FIG. 4.

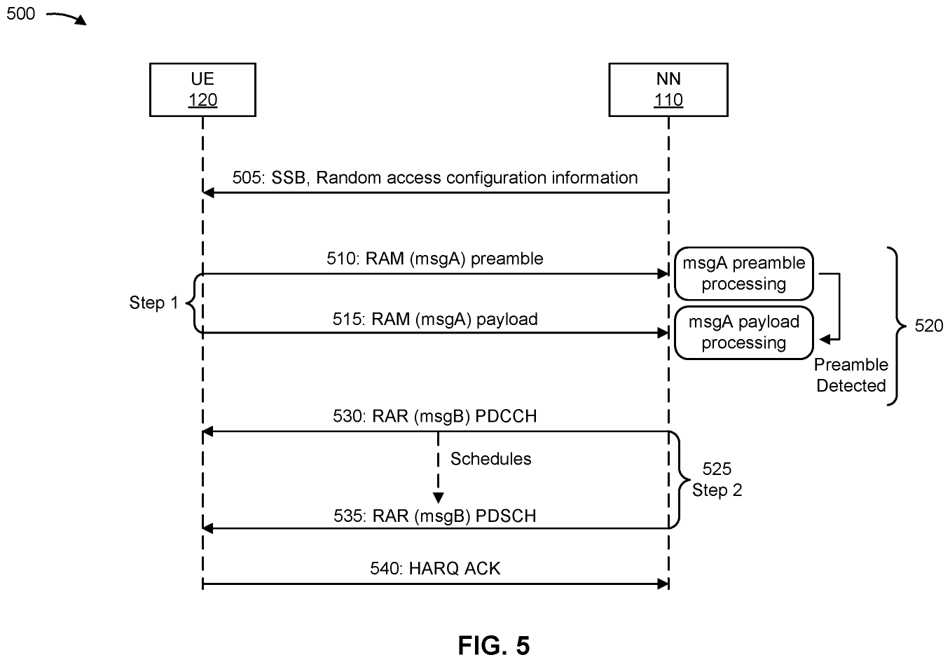

FIG. 5 is a diagram illustrating an example 500 of a two-step random access procedure, in accordance with the present disclosure. As shown in FIG. 5, a network node 110 and a UE 120 may communicate with one another to perform the two-step random access procedure.

As shown by reference number 505, the network node 110 may transmit, and the UE 120 may receive, one or more SSBs and random access configuration information, in a similar manner as described in connection with FIG. 4.

As shown by reference number 510, the UE 120 may transmit, and the network node 110 may receive, a RAM preamble. As shown by reference number 515, the UE 120 may transmit, and the network node 110 may receive, a RAM payload. As shown, the UE 120 may transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, as described in connection with FIG. 4. For example, the RAM preamble may include some or all contents of message 1 (e.g., a PRACH preamble), and the RAM payload may include some or all contents of message 3 (e.g., a UE identifier, UCI, and/or a PUSCH transmission). In some aspects, the UE may include information relating to a performance indicator associated with the UE in the RAM payload, as described herein.

As shown by reference number 520, the network node 110 may receive the RAM preamble transmitted by the UE 120. If the network node 110 successfully receives and decodes the RAM preamble, the network node 110 may then receive and decode the RAM payload.

As shown by reference number 525, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure, as described in connection with FIG. 4. For example, the RAR message may include the detected PRACH preamble identifier, the detected UE identifier, a timing advance value, and/or contention resolution information.

As shown by reference number 530, as part of the second step of the two-step random access procedure, the network node 110 may transmit a PDCCH communication for the RAR. The PDCCH communication may schedule a PDSCH communication that includes the RAR. For example, the PDCCH communication may indicate a resource allocation (e.g., in downlink control information (DCI)) for the PDSCH communication.

As shown by reference number 535, as part of the second step of the two-step random access procedure, the network node 110 may transmit the PDSCH communication for the RAR, as scheduled by the PDCCH communication. The RAR may be included in a MAC PDU of the PDSCH communication. As shown by reference number 540, if the UE 120 successfully receives the RAR, the UE 120 may transmit an HARQ ACK.

As indicated above, FIG. 5 is provided as an example. Other examples may differ from what is described with regard to FIG. 5.

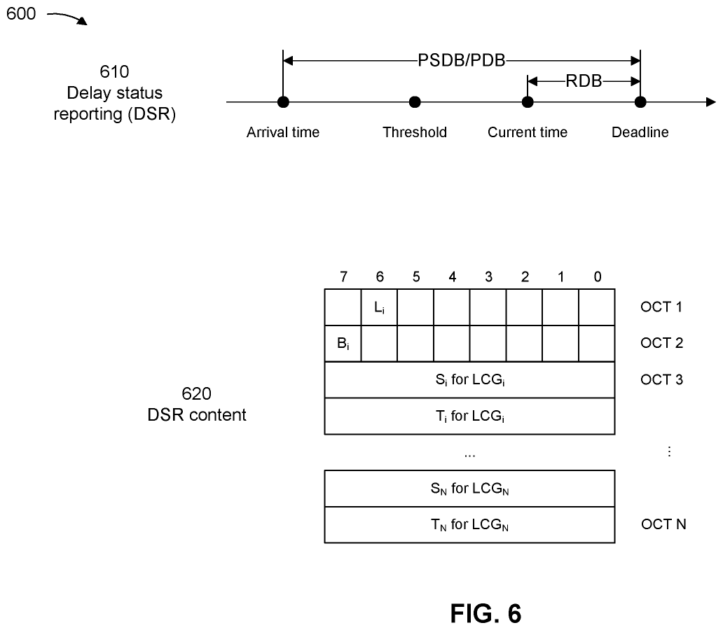

FIG. 6 is a diagram illustrating examples 600 of delay status reporting and delay statistics reporting, in accordance with the present disclosure. More particularly, as described herein, delay status reporting and/or delay statistics reporting (sometimes referred to as statistical delay reporting) may be useful to schedule delay-sensitive traffic, such as XR traffic, more efficiently than using a PDU set delay budget (PSDB) or a packet delay budget (PDB). For example, as shown by reference number 610 in FIG. 6, a delay budget (e.g., a PSDB or PDB) generally starts when a PDU or a PDU set arrives in an uplink buffer associated with a UE, rather than when a network node is informed about the existence of a PDU from a buffer status report (BSR) that the UE transmits to indicate how much uplink data is in the uplink buffer. Accordingly, the PSDB/PDB may be insufficient to schedule XR or other delay-sensitive traffic efficiently, because the network node is unable to know the remaining delay budget (RDB) for buffered uplink data (e.g., because the BSR does not indicate how much data is buffered for how long). As a result, the network node is unable to determine when the delay budget associated with a buffered PDU will deplete, whereby a PSDB/PDB alone cannot adequately enable enhanced scheduling for delay-sensitive traffic. Accordingly, because the RDB (rather than the PSDB/PDB) indicates how soon a network node needs to provide uplink grants, the network node may configure a UE to dynamically report an RDB associated with a PDU stored in a Layer 2 (L2) buffer associated with the UE, where the RDB may be defined as a difference between a PDB or PSDB of a QoS flow associated with the PDU and the time that has elapsed since the PDU was received at an SDAP layer. In this way, the network node may know the RDB for buffered uplink data and issue uplink grants before the deadline associated with the buffered uplink data.

In some aspects, as described herein, one or more triggers may be defined (e.g., in a wireless communication standard) and/or configured (e.g., by the network node) to define when a UE is to transmit a delay status report (DSR) to the network node. For example, in some aspects, the network node may generally configure one or more logical channel groups (LCGs) for which the UE is to provide a DSR (e.g., the network configures which LCGs should report DSR), where each LCG may include one or more logical channels (LCHs). For example, the UE may be configured with multiple LCHs, and may have data associated with one or more LCHs available for transmission at a time when the UE has an allocation of uplink resources. In general, transmission of a DSR may be event-triggered or timer-triggered, which may be configured per LCG. For example, in an event-triggered DSR, the network node may configure a reporting threshold related to an RDB for an associated LCG, and a DSR may be triggered (e.g., the UE may transmit a DSR for the associated LCG) based on a minimum RDB among all PDUs in the associated LCG failing to satisfy (e.g., is below) the reporting threshold. Additionally, or alternatively, in a timer-triggered DSR, the network node may configure a periodic DSR timer for an LCG, and expiry of the DSR timer may trigger a DSR. In general, a triggered DSR (e.g., an event-triggered or timer-triggered DSR) may remain pending until an associated DSR MAC control element (MAC-CE) is included in a PUSCH transmission, and a pending DSR may trigger a scheduling request until the pending DSR has been cancelled.

For example, as further shown in FIG. 6, reference number 620 depicts an example format for the content of a DSR MAC-CE. For example, the DSR MAC-CE may include one or more octets providing a bitmap to indicate which LCGs the UE is reporting in the DSR MAC-CE, where each LCG is associated with a first octet that indicates an amount of data in the reported LCG at a sampling instance, Sᵢ, which may encoded using legacy or new BSR tables, and a duration between the sampling instance and a transmission time of the DSR in a PUSCH, Tᵢ, which may be indicated in a unit of slots (e.g., with a maximum of 32 milliseconds (ms)×8 slots/ms). In some aspects, the sampling instance may correspond to a slot in which the DSR was triggered or a slot in which the MAC PDU containing the DSR is assembled (e.g., which may provide greater accuracy).

Additionally, or alternatively, a network node may configure a UE to measure and report downlink and/or uplink delay statistics for one or more DRBs (e.g., that are used to transport the delay-sensitive traffic). For example, in some cases (e.g., where a traffic flow has a varying frame rate), a UE may be unable to signal nominal arrival times and delivery deadlines for each PDU or PDU set. In such cases, the network node has to schedule the one or more data radio bearers (DRBs) using a fixed delay budget, which can result in conservative deadlines. Accordingly, in some aspects, the network node may configure the UE to provide feedback on delay statistics (e.g., an average delay, a standard deviation, or the like) such that the network node can adapt the delay budgets that are configured and/or applied to compensate for scheduling inefficiencies. For example, on a downlink, the UE can be configured to measure the amount of delay budget that is remaining before a delivery deadline (e.g., a residual delay budget) for a PDU or a PDU set and to report the residual delay budget to the network node. The network node can then use the residual delay budget reported by the UE to adjust the delay budget that the network node applies to downlink traffic (e.g., the network node may increase the delay budget applied to downlink traffic if the residual delay budget is large). Additionally, or alternatively, on an uplink, the UE can be configured to measure and report the amount of delay that a PDU or a PDU set experienced when successfully received by the network node (e.g., upon reception of a positive RLC status report). The network node can then use the reported delay statistics to estimate the residual delay budget for the rest of the connection (e.g., by subtracting the delay reported by the UE from an end-to-end delay budget that is provisioned for a flow).

In some examples, the UE may perform DSR on an uplink in connection with XR. As described herein, the UE may transmit data volume information, associated with delay information (e.g., a remaining time), in a MAC-CE. In some examples, the UE may use one or more BSR tables in connection with XR. These BSR tables may be static (e.g., specified) or dynamic (e.g., generated by the UE and differing in accordance with an RRC parameter configured for the UE). One or more BSR triggering conditions may be defined to provide timely availability of buffer status information at the network node.

In some examples, a UE may calculate and report a remaining time (e.g., one or multiple values) based on a PDCP discard timer value. If the UE reports the remaining time, a reference time for the remaining time may be determined from a point of a first transmission of the information (e.g., which may be impacted by intra-UE prioritization).

In a typical handover procedure, during a RACH procedure between the UE and a target network node, the target network node may not have access to any information that indicates the delay status or delay statistics that the UE is experiencing. For example, the UE may be unable to transmit a DSR to the target network node via a MAC-CE prior to connecting to the target network node. Consequently, uplink scheduling is deferred until after the handover is complete, which increases the delay associated with uplink traffic (e.g., associated with uplink services or applications), which is particularly troublesome for XR services or other traffic associated with delay-sensitive applications and/or a tight delay budget. Moreover, while network nodes may be capable of sharing delay status information associated with the UE (e.g., via X2 signaling), the forwarding of the delay status information from a source network node to a target network node is associated with a delay. Relatedly, a network node may lack information that indicates an energy status, a battery status, and/or a power consumption of a UE prior to the UE establishing a connection with the network node.

Some techniques and apparatuses described herein enable a UE to inform a network node about the UE's uplink experienced delay status during a RACH procedure. In some aspects, the UE can inform the network node about the UE's delay status using a RACH preamble (e.g., a msg1 communication) and/or using a RACH occasion (e.g., a time and frequency occasion). For example, a msg1 communication of a four-step random access procedure or a msgA communication of a two-step random access procedure, and/or a RACH occasion, can be used to indicate the UE's delay status. In some aspects, the UE may transmit a particular RACH preamble to indicate the UE's delay status (e.g., the UE can inform the network node about the UE's delay status through the use of specific preambles). Additionally, or alternatively, the UE may transmit in a particular RACH occasion, or in a RACH occasion of a particular RACH occasion group, to indicate the UE's delay status (e.g., RACH occasions or RACH occasion groups may be tied to delays). In other words, the UE may implicitly indicate the UE's delay status to the network node by transmitting a communication of a RACH procedure using a particular RACH preamble and/or using a particular RACH occasion.

The network node may optimize scheduling in accordance with the delay status of the UE. For example, based on delay status information associated with one or more UEs, the network node can optimize scheduling to give preference to UEs with higher delay sensitivities (e.g., the network node can optimize scheduling where higher delay sensitive UEs are given certain preferences). Scheduling UEs in accordance with delay status information may be useful in delay-sensitive applications, such as XR or in ultra-reliable low-latency communication (URLLC). A similar reporting mechanism can additionally, or alternatively, be used by the UE to inform the network node about the UE's energy status, which may be useful in connection with ambient IoT and/or energy harvesting. For example, scheduling UEs in accordance with energy status information may be useful to conserve energy, extend battery life, or the like.

As indicated above, FIG. 6 is provided as an example. Other examples may differ from what is described with regard to FIG. 6.

FIG. 7 is a diagram of an example 700 associated with UE performance indication in random access, in accordance with the present disclosure. As shown in FIG. 7, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 7.

Example 700 relates to the UE performing a transmission in connection with a RACH procedure (e.g., a four-step RACH procedure or a two-step RACH procedure) that indicates a performance indicator (e.g., a key performance indicator (KPI)) associated with (e.g., experienced by) the UE. A performance indicator may refer to a characteristic relating to the UE (e.g., where changes to the performance indicator may affect a performance of the UE). In some aspects, the performance indicator may be an uplink delay status (e.g., a DSR) associated with the UE, as described herein. For example, a delay experienced by the UE may refer to a delay from packet arrival at PDCP upper SDAP until the uplink grant to transmit the packet is available, which may include a delay associated with receiving a grant for resources (e.g., from sending a scheduling request (SR) or RACH to receiving a first grant). Additionally, or alternatively, the performance indicator may be an energy status, a battery status, and/or a power consumption associated with the UE.

As shown by reference number 705, the network node may transmit (e.g., using communication manager 150, transmission component 1104, transmit processor 220, TX MIMO processor 230, modem 232, antenna 234, controller/processor 240, memory 242, and/or scheduler 246), and the UE may receive (e.g., using communication manager 140, reception component 1002, antenna 252, modem 254, MIMO detector 256, receive processor 258, controller/processor 280, and/or memory 282), configuration information. In some aspects, the UE may receive the configuration information via one or more of system information (e.g., a master information block (MIB) and/or a SIB, among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate a plurality of RACH occasions (e.g., time and frequency resources that can be used to transmit a communication of a RACH procedure). For example, the RACH occasions may be PRACH occasions. In some aspects, the configuration information may indicate a plurality of RACH occasion groups (e.g., groups of one or more RACH occasions). The RACH occasions may be associated with a plurality of values for a performance indicator. For example, the RACH occasions may have associations with (e.g., may be mapped to) the values. As an example, RACH occasion groups may have associations with (e.g., may be mapped to) the values.

In some aspects, particular RACH occasions may be used by UEs associated with an experienced performance indicator (e.g., delay status, energy status, battery status, and/or power consumption) greater than a threshold (e.g., the configured RACH occasion resources that are to be used by UEs if the delay experienced, such as uplink experienced delay, is greater than a threshold). In some aspects, particular RACH occasions may be used by UEs associated with an experienced performance indicator (e.g., delay status, energy status, battery status, and/or power consumption) greater than a first threshold and less than a second threshold (e.g., the configured RACH occasion resources that are to be used by UEs if the delay experienced is greater than a first threshold and less than a second threshold). In some aspects, particular RACH occasions may be used by UEs associated with an experienced performance indicator (e.g., delay status, energy status, battery status, and/or power consumption) less than a threshold (e.g., the configured RACH occasion resources that are to be used by UEs if the delay experienced is less than a threshold). In some aspects, the network node may transmit (e.g., using communication manager 150, transmission component 1104, transmit processor 220, TX MIMO processor 230, modem 232, antenna 234, controller/processor 240, memory 242, and/or scheduler 246), and the UE may receive (e.g., using communication manager 140, reception component 1002, antenna 252, modem 254, MIMO detector 256, receive processor 258, controller/processor 280, and/or memory 282), an indication (e.g., in the configuration information) of one or more RACH occasion groups that are to be used only if a value for the performance indicator satisfies a threshold (e.g., the network node may indicate that certain groups of RACH occasions may only be used if a delay experienced satisfies a particular threshold).

Additionally, or alternatively, the configuration information may indicate a plurality of RACH preambles usable by the UE (e.g., indicate RACH preambles, of a set of RACH preambles stored by the UE, from which the UE may select a RACH preamble for use). For example, the configuration information may indicate a set of values that can be encoded into a preamble sequence, a preamble format to use, one or more groupings of RACH preambles, one or more conditions for selecting a RACH preamble, or the like. The RACH preambles may be associated with the plurality of values for the performance indicator (e.g., groups of sequences can be tied to certain delays). For example, the RACH preambles may have associations with (e.g., may be mapped to) the values. As an example, RACH preamble groups (e.g., groups of preamble sequences) may have associations with (e.g., may be mapped to) the values.

In some aspects, particular RACH preambles may be used by UEs associated with an experienced performance indicator (e.g., delay status, energy status, battery status, and/or power consumption) greater than a threshold (e.g., the RACH preambles that are to be used by UEs if the delay experienced, such as uplink experienced delay, is greater than a threshold). In some aspects, particular RACH preambles may be used by UEs associated with an experienced performance indicator (e.g., delay status, energy status, battery status, and/or power consumption) greater than a first threshold and less than a second threshold (e.g., the RACH preambles that are to be used by UEs if the delay experienced is greater than a first threshold and less than a second threshold). In some aspects, particular RACH preambles may be used by UEs associated with an experienced performance indicator (e.g., delay status, energy status, battery status, and/or power consumption) less than a threshold (e.g., the RACH preambles that are to be used by UEs if the delay experienced is less than a threshold).

In some aspects, the RACH occasions (e.g., PRACH occasions) may be configured for the UE (e.g., by the network node or a source network node) via an RRC parameter (e.g., delaydependent-prach-ConfigurationIndex), where the RACH occasions may be associated with an uplink delay experienced by the UE, or an energy status, battery status, or power consumption experienced by the UE. In some aspects, the UE may receive an indication (e.g., in a MAC-CE and/or DCI) indicating an activation and/or a deactivation of one or more of the RACH occasions. In some aspects, the associations between the RACH occasions or the RACH occasion groups and the values may be indicated by the configuration information, or the UE may be provisioned with information indicating the associations (e.g., the associations are specified). In some aspects, the associations between the RACH preambles or the RACH preamble groups and the values may be indicated by the configuration information, or the UE may be provisioned with information indicating the associations (e.g., groups of sequences and associated delay status, energy status, battery status, and/or power consumption can be specified). Associations between RACH occasions or RACH preambles and the values, as described herein, may be associations to discrete values, value ranges, threshold values, or the like.

In some aspects, the configuration information may indicate a plurality of probabilities of accessing the RACH occasions. For example, a probability of a UE with greater delay sensitivity accessing a particular RACH occasion may be higher than a probability of a UE with lesser delay sensitivity accessing the RACH occasion (e.g., a delay sensitive UE can be given a higher probability to access certain RACH occasions). In this way, in accordance with the delay status of the UE, the UE may select a RACH occasion associated with a higher probability (e.g., a highest probability) of the UE accessing. The configuration information indicating the probabilities may be in system information, such as a MIB and/or a SIB (e.g., the probability measure can be provided in a MIB and/or a SIB).

Additionally, or alternatively, the configuration information may indicate one or more PUSCH occasions (e.g., time and frequency resources that can be used to transmit a PUSCH communication). The PUSCH occasions may be for a msgA (e.g., a RAM payload) of a two-step RACH procedure. The configuration information indicating the one or more PUSCH occasions may be in system information, such as a MIB or a SIB.

The UE may configure itself based at least in part on the configuration information. In some aspects, the UE may be configured to perform one or more operations described herein based at least in part on the configuration information. In some aspects, the configuration information may include information transmitted via multiple communications.

As shown by reference number 710, the UE may select (e.g., using communication manager 140, controller/processor 280, or memory 282) a RACH occasion and/or a RACH preamble that the UE is to use for a RACH procedure (e.g., a four-step RACH procedure or a two-step RACH procedure). For example, the UE may select the RACH occasion from a plurality of RACH occasions (e.g., that are configured for the UE) and/or select the RACH preamble from a plurality of RACH preambles (e.g., that are stored by the UE). The UE may select the RACH occasion and/or the RACH preamble in accordance with a performance indicator (e.g., delay status, energy status, battery status, and/or power consumption) associated with the UE. For example, the UE may determine a value for the performance indicator (e.g., by detecting the value or by measuring the performance indicator and computing the value), and the UE may select the RACH occasion and/or the RACH preamble in accordance with the value for the performance indicator. As an example, the UE may select a particular RACH occasion and/or a particular RACH preamble according to whether the value for the performance indicator satisfies a threshold.

In some aspects, the RACH occasion may be associated with a first RACH occasion group or a second RACH occasion group according to whether the value for the performance indicator satisfies a threshold. For example, the UE may use a first configured RACH occasion group if the value (e.g., the delay status) is greater than a threshold (e.g., as defined in a specification). As another example, the UE may use a second configured RACH occasion group if the value (e.g., the delay status) is less than a threshold (e.g., as defined in a specification). In some aspects, the RACH occasion and/or the RACH preamble selected by the UE may be associated with XR communication or URLLC (e.g., XR or URLLC, associated with tight delay budgets, can be assigned CFRA or may use certain preamble sequences).

As shown by reference number 715, the UE may generate (e.g., using communication manager 140, controller/processor 280, and/or memory 282) a RACH preamble. The UE may generate the RACH preamble by combining a preamble sequence (e.g., a traditional preamble sequence) with encoded information relating to a performance indicator (e.g., encoded delay information). For example, the UE may quantize an experienced performance indicator (e.g., an experienced delay) into a particular value (e.g., the delay can be quantized into certain values). Continuing with the example, the UE may encode the experienced performance indicator (e.g., the experienced delay) into the preamble sequence. As an example, a delay value may be represented through altering the phase and/or the amplitude of the preamble sequence. Thus, the network node may receive the preamble sequence and can infer the experienced performance indicator (e.g., the experienced uplink delay) from the received preamble sequence (e.g., thereby allowing the network node to prioritize scheduling for the UE).

As shown by reference number 720, the UE may transmit (e.g., using communication manager 140, transmission component 1004, antenna 252, modem 254, transmit processor 264, TX MIMO processor 266, controller/processor 280, and/or memory 282), and the network node may receive (e.g., using communication manager 150, reception component 1102, modem 232, antenna 234, MIMO detector 236, receive processor 238, controller/processor 240, memory 242, and/or scheduler 246), a communication of the RACH procedure. In some aspects, the UE may transmit the communication using the RACH occasion (e.g., selected by the UE), of the plurality of RACH occasions, to indicate the value for the performance indicator (e.g., delay status, energy status, battery status, and/or power consumption) associated with the UE. Additionally, or alternatively, the UE may transmit the communication using the RACH preamble (e.g., selected by the UE and/or generated by the UE), of the plurality of RACH preambles, to indicate the value for the performance indicator associated with the UE. As described above, the RACH preamble may include a preamble sequence encoded with information indicating the value for the performance indicator. Accordingly, the network node may decode the RACH preamble (e.g., decode the sequence) to extract the information indicating the vale for the performance indicator.

Transmission of the communication using a particular RACH occasion and/or a particular RACH preamble may provide an implicit indication of the value for the performance indicator. The value for the performance indicator indicated by the RACH occasion and/or the RACH preamble may be a single value or a range of values. The communication may be a RAM (e.g., a msg1) of a four-step RACH procedure.

In some aspects, the UE may transmit the communication using a PUSCH occasion (e.g., of the one or more PUSCH occasions configured for the UE). Here, the communication may indicate the value for the performance indicator in the communication. For example, the communication may be a PUSCH communication of a msgA communication of a two-step RACH procedure, and the PUSCH communication may include a MAC-CE (e.g., a DSR MAC-CE, as described herein) indicating the value for the performance indicator (e.g., for a two-step RACH procedure, the UE can transmit a MAC-CE in a timing-advance-free PUSCH of a msgA).

As shown by reference number 725, the network node may transmit (e.g., using communication manager 150, transmission component 1104, transmit processor 220, TX MIMO processor 230, modem 232, antenna 234, controller/processor 240, memory 242, and/or scheduler 246), and the UE may receive (e.g., using communication manager 140, reception component 1002, antenna 252, modem 254, MIMO detector 256, receive processor 258, controller/processor 280, and/or memory 282), in response to the communication of the RACH procedure, an additional communication of the RACH procedure. For example, the additional communication may be a RAR communication. The RAR communication may be in a RAR window that is dynamically adjusted according to the value for the performance indicator. For example, the network node may dynamically adjust the RAR window size based on the reported delay (e.g., since the network node is aware of the experienced delay by the UE in the msg1 or msgA preamble, or through the RACH occasions, the network node can dynamically adjust the RAR window size based on the reported delay). For example, if the UE reports a high delay, the RAR window can be reduced.

The network node and the UE may complete the RACH procedure as described in connection with FIG. 4 (for a four-step RACH procedure) or FIG. 5 (for a two-step RACH procedure). In some aspects, the network node may transmit (e.g., using communication manager 150, transmission component 1104, transmit processor 220, TX MIMO processor 230, modem 232, antenna 234, controller/processor 240, memory 242, and/or scheduler 246), and the UE may receive (e.g., using communication manager 140, reception component 1002, antenna 252, modem 254, MIMO detector 256, receive processor 258, controller/processor 280, and/or memory 282), scheduling (e.g., an uplink grant) for an uplink communication of the UE. For example, the scheduling may be based on the indicated value for the performance indicator. As an example, the scheduling may be based on the delay status of the UE (e.g., relative to the delay statuses of other UEs). For example, UEs associated with a lower remaining delay budget may be scheduled sooner than UEs associated with a higher remaining delay budget. As another example, the scheduling may be based on the energy status, battery status, and/or power consumption of the UE.

Based at least in part on the UE informing the network node, during a RACH procedure, of information relating to the performance indicator (e.g., a delay status, an energy status, a battery status, and/or a power consumption, among other examples) associated with the UE, the network node can start to determine uplink scheduling parameters for the UE based on the reported information, thereby facilitating efficient scheduling. Furthermore, using a communication of the RACH procedure to indicate the information relating to the performance indicator reduces signaling between the UE and the network node, thereby conserving computing resources of the UE and the network node, and conserving network resources.

As indicated above, FIG. 7 is provided as an example. Other examples may differ from what is described with respect to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with UE performance indication in random access.

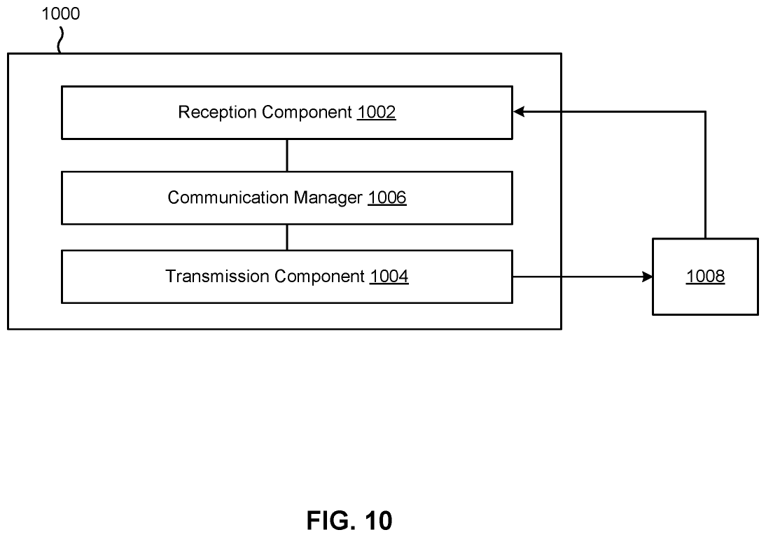

As shown in FIG. 8, in some aspects, process 800 may include transmitting a communication of a RACH procedure using a RACH occasion, of a plurality of RACH occasions, or a RACH preamble, of a plurality of RACH preambles, to indicate a value for a performance indicator associated with the UE, or using a PUSCH occasion and indicating the value for the performance indicator in the communication (block 810). For example, the UE (e.g., using transmission component 1004 and/or communication manager 1006, depicted in FIG. 10) may transmit a communication of a RACH procedure using a RACH occasion, of a plurality of RACH occasions, or a RACH preamble, of a plurality of RACH preambles, to indicate a value for a performance indicator associated with the UE, or using a PUSCH occasion and indicating the value for the performance indicator in the communication, as described in connection with reference number 720 of FIG. 7.

As further shown in FIG. 8, in some aspects, process 800 may include receiving, in response to the communication of the RACH procedure, an additional communication of the RACH procedure (block 820). For example, the UE (e.g., using reception component 1002 and/or communication manager 1006, depicted in FIG. 10) may receive, in response to the communication of the RACH procedure, an additional communication of the RACH procedure, as described in connection with reference number 725 of FIG. 7.

Process 800 may include additional aspects, such as any single aspect or any combination of aspects described below and/or in connection with one or more other processes described elsewhere herein.

In a first aspect, the performance indicator is an uplink delay status. In a second aspect, alone or in combination with the first aspect, the performance indicator is at least one of an energy status, a battery status, or a power consumption.

In a third aspect, alone or in combination with one or more of the first and second aspects, the plurality of RACH occasions have associations with a plurality of values for the performance indicator. In a fourth aspect, alone or in combination with one or more of the first through third aspects, the plurality of RACH preambles have associations with a plurality of values for the performance indicator.

In a fifth aspect, alone or in combination with one or more of the first through fourth aspects, process 800 includes receiving (e.g., using reception component 1002 and/or communication manager 1006, depicted in FIG. 10) configuration information indicating a plurality of probabilities of accessing the plurality of RACH occasions. In a sixth aspect, alone or in combination with one or more of the first through fifth aspects, the RACH occasion or the RACH preamble is associated with XR communication or URLLC. In a seventh aspect, alone or in combination with one or more of the first through sixth aspects, the RACH preamble includes a preamble sequence encoded with information indicating the value for the performance indicator.

In an eighth aspect, alone or in combination with one or more of the first through seventh aspects, the RACH occasion is associated with a first RACH occasion group or a second RACH occasion group according to whether the value for the performance indicator satisfies a threshold. In a ninth aspect, alone or in combination with one or more of the first through eighth aspects, process 800 includes receiving (e.g., using reception component 1002 and/or communication manager 1006, depicted in FIG. 10) an indication of one or more RACH occasion groups that are to be used only if the value for the performance indicator satisfies a threshold.

In a tenth aspect, alone or in combination with one or more of the first through ninth aspects, the communication of the RACH procedure is a PUSCH communication of a msgA communication of a two-step RACH procedure, and the PUSCH communication includes a MAC-CE indicating the value for the performance indicator. In an eleventh aspect, alone or in combination with one or more of the first through tenth aspects, the additional communication is an RAR communication that is in an RAR window dynamically adjusted according to the value for the performance indicator.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with UE performance indication in random access.

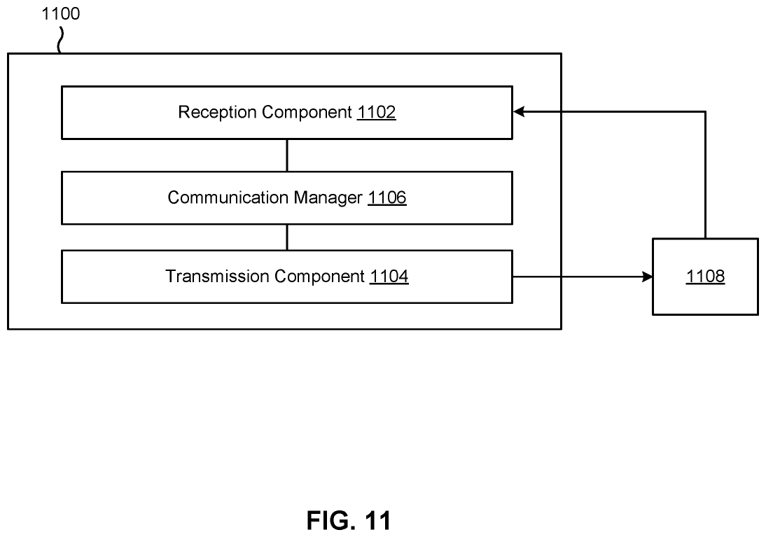

As shown in FIG. 9, in some aspects, process 900 may include receiving a communication of a RACH procedure that uses a RACH occasion, of a plurality of RACH occasions, or a RACH preamble, of a plurality of RACH preambles, to indicate a value for a performance indicator associated with a UE, or that uses a PUSCH occasion and indicates the value for the performance indicator in the communication (block 910). For example, the network node (e.g., using reception component 1102 and/or communication manager 1106, depicted in FIG. 11) may receive a communication of a RACH procedure that uses a RACH occasion, of a plurality of RACH occasions, or a RACH preamble, of a plurality of RACH preambles, to indicate a value for a performance indicator associated with a UE, or that uses a PUSCH occasion and indicates the value for the performance indicator in the communication, as described in connection with reference number 720 of FIG. 7.

As further shown in FIG. 9, in some aspects, process 900 may include transmitting, in response to the communication of the RACH procedure, an additional communication of the RACH procedure (block 920). For example, the network node (e.g., using transmission component 1104 and/or communication manager 1106, depicted in FIG. 11) may transmit, in response to the communication of the RACH procedure, an additional communication of the RACH procedure, as described in connection with reference number 725 of FIG. 7.

Process 900 may include additional aspects, such as any single aspect or any combination of aspects described below and/or in connection with one or more other processes described elsewhere herein.

In a first aspect, the performance indicator is an uplink delay status. In a second aspect, alone or in combination with the first aspect, the performance indicator is at least one of an energy status, a battery status, or a power consumption.

In a third aspect, alone or in combination with one or more of the first and second aspects, the plurality of RACH occasions have associations with a plurality of values for the performance indicator. In a fourth aspect, alone or in combination with one or more of the first through third aspects, the plurality of RACH preambles have associations with a plurality of values for the performance indicator.

In a fifth aspect, alone or in combination with one or more of the first through fourth aspects, process 900 includes transmitting configuration information indicating a plurality of probabilities of accessing the plurality of RACH occasions. In a sixth aspect, alone or in combination with one or more of the first through fifth aspects, the RACH occasion or the RACH preamble is associated with XR communication or URLLC. In a seventh aspect, alone or in combination with one or more of the first through sixth aspects, the RACH preamble includes a preamble sequence encoded with information indicating the value for the performance indicator.

In an eighth aspect, alone or in combination with one or more of the first through seventh aspects, the RACH occasion is associated with a first RACH occasion group or a second RACH occasion group according to whether the value for the performance indicator satisfies a threshold. In a ninth aspect, alone or in combination with one or more of the first through eighth aspects, process 900 includes transmitting an indication of one or more RACH occasion groups that are to be used only if the value for the performance indicator satisfies a threshold.

In a tenth aspect, alone or in combination with one or more of the first through ninth aspects, the communication of the RACH procedure is a PUSCH communication of a msgA communication of a two-step RACH procedure, and the PUSCH communication includes a MAC-CE indicating the value for the performance indicator. In an eleventh aspect, alone or in combination with one or more of the first through tenth aspects, the additional communication is an RAR communication that is in an RAR window dynamically adjusted according to the value for the performance indicator.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit a communication of a RACH procedure using a RACH occasion, of a plurality of RACH occasions, or a RACH preamble, of a plurality of RACH preambles, to indicate a value for a performance indicator associated with the apparatus 1000, or using a PUSCH occasion and indicating the value for the performance indicator in the communication. The reception component 1002 may receive, in response to the communication of the RACH procedure, an additional communication of the RACH procedure. The reception component 1002 may receive configuration information indicating a plurality of probabilities of accessing the plurality of RACH occasions. The reception component 1002 may receive an indication of one or more RACH occasion groups that are to be used only if the value for the performance indicator satisfies a threshold.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a communication of a RACH procedure that uses a RACH occasion, of a plurality of RACH occasions, or a RACH preamble, of a plurality of RACH preambles, to indicate a value for a performance indicator associated with a UE, or that uses a PUSCH occasion and indicates the value for the performance indicator in the communication. The transmission component 1104 may transmit, in response to the communication of the RACH procedure, an additional communication of the RACH procedure. The transmission component 1104 may transmit configuration information indicating a plurality of probabilities of accessing the plurality of RACH occasions. The transmission component 1104 may transmit an indication of one or more RACH occasion groups that are to be used only if the value for the performance indicator satisfies a threshold.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: transmitting a communication of a random access channel (RACH) procedure using a RACH occasion, of a plurality of RACH occasions, or a RACH preamble, of a plurality of RACH preambles, to indicate a value for a performance indicator associated with the UE, or using a physical uplink shared channel (PUSCH) occasion and indicating the value for the performance indicator in the communication; and receiving, in response to the communication of the RACH procedure, an additional communication of the RACH procedure.

Aspect 2: The method of Aspect 1, wherein the performance indicator is an uplink delay status.

Aspect 3: The method of any of Aspects 1-2, wherein the performance indicator is at least one of an energy status, a battery status, or a power consumption.

Aspect 4: The method of any of Aspects 1-3, wherein the plurality of RACH occasions have associations with a plurality of values for the performance indicator.

Aspect 5: The method of any of Aspects 1-4, wherein the plurality of RACH preambles have associations with a plurality of values for the performance indicator.

Aspect 6: The method of any of Aspects 1-5, further comprising: receiving configuration information indicating a plurality of probabilities of accessing the plurality of RACH occasions.

Aspect 7: The method of any of Aspects 1-6, wherein the RACH occasion or the RACH preamble is associated with extended reality communication or ultra-reliable low-latency communication.

Aspect 8: The method of any of Aspects 1-7, wherein the RACH preamble includes a preamble sequence encoded with information indicating the value for the performance indicator.

Aspect 9: The method of any of Aspects 1-8, wherein the RACH occasion is associated with a first RACH occasion group or a second RACH occasion group according to whether the value for the performance indicator satisfies a threshold.

Aspect 10: The method of any of Aspects 1-9, further comprising: receiving an indication of one or more RACH occasion groups that are to be used only if the value for the performance indicator satisfies a threshold.

Aspect 11: The method of any of Aspects 1-10, wherein the communication of the RACH procedure is a PUSCH communication of a message A (msgA) communication of a two-step RACH procedure, and wherein the PUSCH communication includes a medium access control control element (MAC-CE) indicating the value for the performance indicator.

Aspect 12: The method of any of Aspects 1-11, wherein the additional communication is a random access response (RAR) communication that is in an RAR window dynamically adjusted according to the value for the performance indicator.

Aspect 13: A method of wireless communication performed by a network node, comprising: receiving a communication of a random access channel (RACH) procedure that uses a RACH occasion, of a plurality of RACH occasions, or a RACH preamble, of a plurality of RACH preambles, to indicate a value for a performance indicator associated with a user equipment (UE), or that uses a physical uplink shared channel (PUSCH) occasion and indicates the value for the performance indicator in the communication; and transmitting, in response to the communication of the RACH procedure, an additional communication of the RACH procedure.

Aspect 14: The method of Aspect 13, wherein the performance indicator is an uplink delay status.

Aspect 15: The method of any of Aspects 13-14, wherein the performance indicator is at least one of an energy status, a battery status, or a power consumption.

Aspect 16: The method of any of Aspects 13-15, wherein the plurality of RACH occasions have associations with a plurality of values for the performance indicator.

Aspect 17: The method of any of Aspects 13-16, wherein the plurality of RACH preambles have associations with a plurality of values for the performance indicator.

Aspect 18: The method of any of Aspects 13-17, further comprising: transmitting configuration information indicating a plurality of probabilities of accessing the plurality of RACH occasions.

Aspect 19: The method of any of Aspects 13-18, wherein the RACH occasion or the RACH preamble is associated with extended reality communication or ultra-reliable low-latency communication.

Aspect 20: The method of any of Aspects 13-19, wherein the RACH preamble includes a preamble sequence encoded with information indicating the value for the performance indicator.

Aspect 21: The method of any of Aspects 13-20, wherein the RACH occasion is associated with a first RACH occasion group or a second RACH occasion group according to whether the value for the performance indicator satisfies a threshold.

Aspect 22: The method of any of Aspects 13-21, further comprising: transmitting an indication of one or more RACH occasion groups that are to be used only if the value for the performance indicator satisfies a threshold.

Aspect 23: The method of any of Aspects 13-22, wherein the communication of the RACH procedure is a PUSCH communication of a message A (msgA) communication of a two-step RACH procedure, and wherein the PUSCH communication includes a medium access control control element (MAC-CE) indicating the value for the performance indicator.

Aspect 24: The method of any of Aspects 13-23, wherein the additional communication is a random access response (RAR) communication that is in an RAR window dynamically adjusted according to the value for the performance indicator.

Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-24.

Aspect 26: An apparatus for wireless communication at a device, the apparatus comprising one or more memories and one or more processors coupled to the one or more memories, the one or more processors configured to cause the device to perform the method of one or more of Aspects 1-24.

Aspect 27: An apparatus for wireless communication, the apparatus comprising at least one means for performing the method of one or more of Aspects 1-24.

Aspect 28: A non-transitory computer-readable medium storing code for wireless communication, the code comprising instructions executable by one or more processors to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

Aspect 30: A device for wireless communication, the device comprising a processing system that includes one or more processors and one or more memories coupled with the one or more processors, the processing system configured to cause the device to perform the method of one or more of Aspects 1-24.

Aspect 31: An apparatus for wireless communication at a device, the apparatus comprising one or more memories and one or more processors coupled to the one or more memories, the one or more processors individually or collectively configured to cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, configured to cause the UE to:
transmit a communication of a random access channel (RACH) procedure using a RACH occasion, of a plurality of RACH occasions, or a RACH preamble, of a plurality of RACH preambles, to indicate a value for a performance indicator associated with the UE, or using a physical uplink shared channel (PUSCH) occasion and indicating the value for the performance indicator in the communication; and
receive, in response to the communication of the RACH procedure, an additional communication of the RACH procedure.

2. The apparatus of claim 1, wherein the performance indicator is an uplink delay status.

3. The apparatus of claim 1, wherein the performance indicator is at least one of an energy status, a battery status, or a power consumption.

4. The apparatus of claim 1, wherein the plurality of RACH occasions have associations with a plurality of values for the performance indicator.

5. The apparatus of claim 1, wherein the plurality of RACH preambles have associations with a plurality of values for the performance indicator.

6. The apparatus of claim 1, wherein the one or more processors are further configured to cause the UE to:
receive configuration information indicating a plurality of probabilities of accessing the plurality of RACH occasions.

7. The apparatus of claim 1, wherein the RACH occasion or the RACH preamble is associated with extended reality communication or ultra-reliable low-latency communication.

8. The apparatus of claim 1, wherein the RACH preamble includes a preamble sequence encoded with information indicating the value for the performance indicator.

9. The apparatus of claim 1, wherein the RACH occasion is associated with a first RACH occasion group or a second RACH occasion group according to whether the value for the performance indicator satisfies a threshold.

10. The apparatus of claim 1, wherein the one or more processors are further configured to cause the UE to:
receive an indication of one or more RACH occasion groups that are to be used only if the value for the performance indicator satisfies a threshold.

11. The apparatus of claim 1, wherein the communication of the RACH procedure is a PUSCH communication of a message A (msgA) communication of a two-step RACH procedure, and
wherein the PUSCH communication includes a medium access control control element (MAC-CE) indicating the value for the performance indicator.

12. The apparatus of claim 1, wherein the additional communication is a random access response (RAR) communication that is in an RAR window dynamically adjusted according to the value for the performance indicator.

13. An apparatus for wireless communication at a network node, comprising:
one or more memories; and
one or more processors, coupled to the one or more memories, configured to cause the network node to:
receive a communication of a random access channel (RACH) procedure that uses a RACH occasion, of a plurality of RACH occasions, or a RACH preamble, of a plurality of RACH preambles, to indicate a value for a performance indicator associated with a user equipment (UE), or that uses a physical uplink shared channel (PUSCH) occasion and indicates the value for the performance indicator in the communication; and
transmit, in response to the communication of the RACH procedure, an additional communication of the RACH procedure.

14. The apparatus of claim 13, wherein the performance indicator is an uplink delay status.

15. The apparatus of claim 13, wherein the performance indicator is at least one of an energy status, a battery status, or a power consumption.

16. The apparatus of claim 13, wherein the plurality of RACH occasions have associations with a plurality of values for the performance indicator.

17. The apparatus of claim 13, wherein the plurality of RACH preambles have associations with a plurality of values for the performance indicator.

18. The apparatus of claim 13, wherein the one or more processors are further configured to cause the network node to:
transmit configuration information indicating a plurality of probabilities of accessing the plurality of RACH occasions.

19. The apparatus of claim 13, wherein the RACH occasion or the RACH preamble is associated with extended reality communication or ultra-reliable low-latency communication.

20. The apparatus of claim 13, wherein the RACH preamble includes a preamble sequence encoded with information indicating the value for the performance indicator.

21. The apparatus of claim 13, wherein the RACH occasion is associated with a first RACH occasion group or a second RACH occasion group according to whether the value for the performance indicator satisfies a threshold.

22. The apparatus of claim 13, wherein the one or more processors are further configured to cause the network node to:
transmit an indication of one or more RACH occasion groups that are to be used only if the value for the performance indicator satisfies a threshold.

23. The apparatus of claim 13, wherein the communication of the RACH procedure is a PUSCH communication of a message A (msgA) communication of a two-step RACH procedure, and
wherein the PUSCH communication includes a medium access control control element (MAC-CE) indicating the value for the performance indicator.

24. The apparatus of claim 13, wherein the additional communication is a random access response (RAR) communication that is in an RAR window dynamically adjusted according to the value for the performance indicator.

25. A method of wireless communication performed by a user equipment (UE), comprising:
transmitting a communication of a random access channel (RACH) procedure using a RACH occasion, of a plurality of RACH occasions, or a RACH preamble, of a plurality of RACH preambles, to indicate a value for a performance indicator associated with the UE, or using a physical uplink shared channel (PUSCH) occasion and indicating the value for the performance indicator in the communication; and
receiving, in response to the communication of the RACH procedure, an additional communication of the RACH procedure.

26. The method of claim 25, further comprising:
receiving configuration information indicating a plurality of probabilities of accessing the plurality of RACH occasions.

27. The method of claim 25, further comprising:
receiving an indication of one or more RACH occasion groups that are to be used only if the value for the performance indicator satisfies a threshold.

28. A method of wireless communication performed by a network node, comprising:
receiving a communication of a random access channel (RACH) procedure that uses a RACH occasion, of a plurality of RACH occasions, or a RACH preamble, of a plurality of RACH preambles, to indicate a value for a performance indicator associated with a user equipment (UE), or that uses a physical uplink shared channel (PUSCH) occasion and indicates the value for the performance indicator in the communication; and
transmitting, in response to the communication of the RACH procedure, an additional communication of the RACH procedure.

29. The method of claim 28, further comprising:
transmitting configuration information indicating a plurality of probabilities of accessing the plurality of RACH occasions.

30. The method of claim 28, further comprising:
transmitting an indication of one or more RACH occasion groups that are to be used only if the value for the performance indicator satisfies a threshold.
